(19) United States
(12) Patent Application Publication
(10) Pub. No.: US 2025/0164352 A1
(43) Pub. Date: May 22, 2025

(54) METHOD, DEVICE, AND SYSTEM FOR INSPECTING ENVIRONMENTAL DEVICE

(71) Applicant: DAIKIN INDUSTRIES, LTD., Osaka (JP)

(72) Inventors: Si PAN, Osaka (JP); Tomohiro YABU, Osaka (JP)

(21) Appl. No.: 19/029,874

(22) Filed: Jan. 17, 2025

Related U.S. Application Data
(63) Continuation of application No. PCT/JP2023/026363, filed on Jul. 19, 2023.

(30) Foreign Application Priority Data
Jul. 20, 2022 (CN) 202210851417.3

(51) Int. Cl. G01M 99/00; G05D 1/689; G05D 105/80; G05D 109/25; G06Q 10/20

(52) U.S. Cl. CPC G01M 99/005; G05D 1/689; G06Q 10/20; G05D 2105/89; G05D 2109/254

(57) ABSTRACT

A method is usable to inspect an environmental device includes using a mobile inspection device to collect data of a site where the environmental device is positioned, generating information of changes in the site where the environmental device is positioned based on the data collected by the mobile inspection device, acquiring operation data of the environmental device and information of an initial operation time of the environmental device, and identifying a health state parameter of the environmental device. The health state parameter of the environmental device is identified based on the information of changes in the site where the environmental device is positioned, the operation data of the environmental device, and the information of the initial operation time of the environmental device.

### CROSS-REFERENCE TO RELATED APPLICATIONS

This is a continuation of International Application No. PCT/JP2023/026363 filed on Jul. 19, 2023, which claims priority to Chinese Patent Application No. 202210851417.3, filed on Jul. 20, 2022. The entire disclosures of these applications are incorporated by reference herein.

### BACKGROUND

### Technical Field

The present invention relates to a field of inspection for a device, and to a method, a device, and a system for inspecting an environmental device.

### Background Art

With rapidly developing social economy and rapidly advancing urbanization and industrialization, environmental devices such as air conditioners have been widely applied.

With extending durable years, an environmental device gradually deteriorates due to aging. Currently and generally, only when there is an abnormality in an environmental device or there is a deteriorated use situation, a user requests an inspection, and a servicing person visits his or her house to inspect the device.

In addition, the servicing person may periodically visit the house to perform an inspection service, and, during an inspection, the servicing person collects operation data of the environmental device, inspects an operation situation of the environmental device, and estimates a degree of deterioration due to aging based on the operation data of the environmental device, for example, to lower a probability of occurrence of an initial abnormality in the environmental device to some extent.

It should be noted that the above description with respect to the technical background is merely provided to clearly and completely describe technical solutions according to the present invention and to ease understanding by those skilled in the art. Even only when these solutions are described in the background art part pertaining to the present invention, it is not considered that the technical solutions described above are known to those skilled in the art.

### SUMMARY

According to a first aspect of an example of the present invention, there is provided a method for inspecting an environmental device, including: using a mobile inspection device to collect data of a site where the environmental device is positioned; generating information of changes in the site where the environmental device is positioned based on the data collected by the mobile inspection device; acquiring operation data of the environmental device and information of an initial operation time of the environmental device; and identifying a health state parameter of the environmental device based on the information of changes in the site where the environmental device is positioned, the operation data of the environmental device, and the information of the initial operation time of the environmental device.

### BRIEF DESCRIPTION OF THE DRAWINGS

It is possible to better understand many aspects of the present invention with reference to accompanying drawings described below. Members illustrated in the drawings are not illustrated in a proportional manner, but are only illustrated for indicating principles of the present invention. To facilitate illustrating and describing some parts of the present invention, corresponding parts may be increased or reduced in size in the drawings. It is possible to combine elements and characteristic information described in one drawing or one embodiment of the present invention with factors and characteristic information illustrated in one or more other drawings or embodiments. Furthermore, in the drawings, like reference numerals designate corresponding members throughout several drawings, and may be used to designate corresponding members in one or more embodiments. The drawings are as described below.

FIG. 1 is a schematic view illustrating a method for inspecting an environmental device, according to Example 1 of the present invention.

FIG. 2 is a schematic view illustrating a scene of the method for inspecting the environmental device, according to Example 1 of the present invention.

FIG. 3 is a schematic view illustrating a method for collecting data of a site by a mobile inspection device, according to Example 1 of the present invention.

FIG. 4 is a schematic view illustrating a method for achieving step 301, according to Example 1 of the present application.

FIG. 5 is a schematic view illustrating another method for achieving step 301, according to Example 1 of the present application.

FIG. 6 is a schematic view illustrating a method for generating a ventilation condition, according to Example 1 of the present application.

FIG. 7 is a schematic view illustrating a method for generating a degree of cleanliness, according to Example 1 of the present application.

FIG. 8 is a schematic view illustrating a method for generating information of shielding, according to Example 1 of the present application.

FIG. 9 is a schematic view illustrating a method for generating a drain state, according to Example 1 of the present application.

FIG. 10 is a schematic view illustrating a method for generating a quantity of exhaust air, according to Example 1 of the present invention.

FIG. 11 is a schematic view illustrating a method for generating an installation state, according to Example 1 of the present invention.

FIG. 12 is a schematic view illustrating a method for generating an ignition risk, according to Embodiment 1 of the present application.

FIG. 13 is a schematic view illustrating a method for generating a refrigerant leakage risk, according to Example 1 of the present application.

FIG. 14 is a schematic view illustrating a method for achieving step 103, according to Example 1 the present application.

FIG. 15 is a schematic view illustrating how to use a ninth model, according to Example 1 of the present application.

FIG. 16 is a schematic view illustrating a network structure of the ninth model, according to Example 1 of the present application.

FIG. 17 is a schematic view illustrating a relationship between exchange value of a device and a degree of deterioration due to aging, according to Example 1 of the present application.

FIG. 18 is a schematic view illustrating an inspection system for an environmental device, according to Example 2 of the present invention.

FIG. 19 is a schematic view illustrating a mobile inspection device according to Example 3 of the present invention.

### DETAILED DESCRIPTION OF EMBODIMENT(S)

### First Embodiment

Preferred embodiments of the present invention will now be described herein with reference to the accompanying drawings.

### Example 1

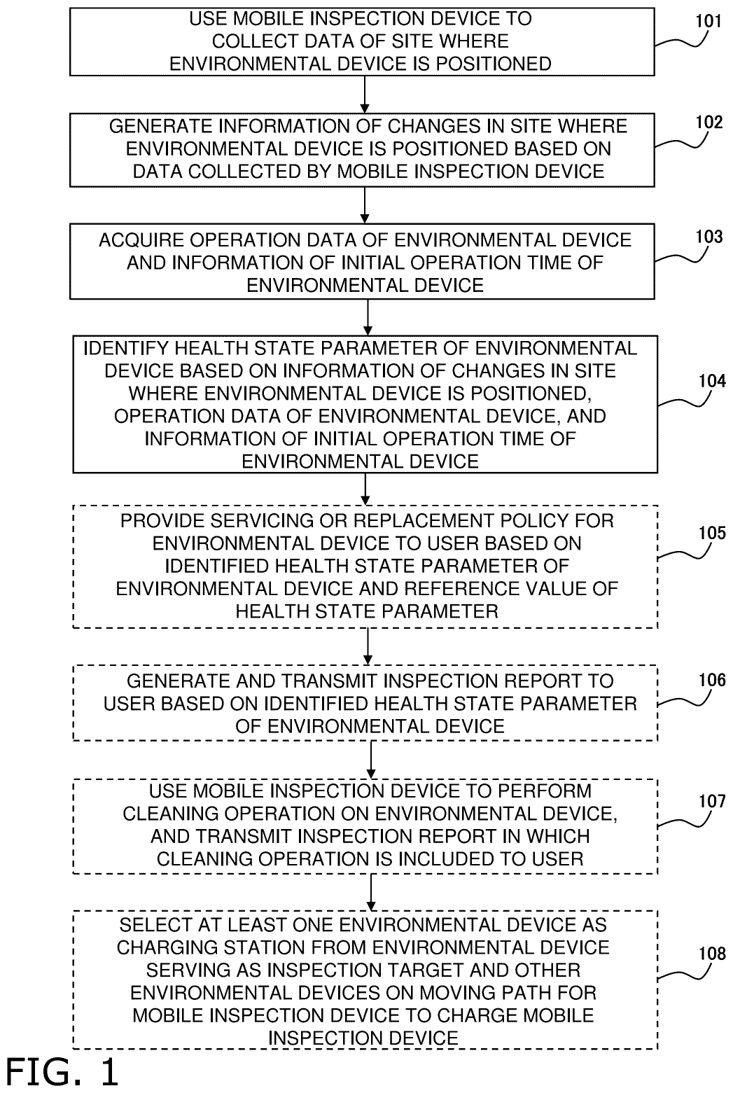

Example 1 of the present invention provides a method for inspecting an environmental device. FIG. 1 is a schematic view illustrating a method for inspecting an environmental device, according to Example 1 of the present invention. As illustrated in FIG. 1, the method includes:
step 101 for using a mobile inspection device to collect data of a site where the environmental device is positioned;
step 102 for generating information of changes in the site where the environmental device is positioned based on the data collected by the mobile inspection device;
step 103 for acquiring operation data of the environmental device and information of an initial operation time of the environmental device; and
step 104 for identifying a health state parameter of the environmental device based on the information of changes in the site where the environmental device is positioned, the operation data of the environmental device, and the information of the initial operation time of the environmental device.

In this way, since a mobile inspection device is used to collect data of an environmental device, information of changes in a site of the device is generated based on the data, and a health state parameter of the environmental device is identified based on the information of changes in the site of the device, operation data of the device, and an initial operation time, a user is able to timely know a health state of the environmental device, and thereby able to determine in advance a decision for maintenance, servicing, and replacement, for example, making it possible to fully utilize value of the environmental device to improve use experience of the user.

Furthermore, since, when a health state parameter of the environmental device is to be identified, information of changes, which has been generated from data collected in the site, and information such as operation data and an operation time of the device are combined with each other, various factors affecting the health state of the device are comprehensively taken into consideration, and accuracy of a result of estimation is improved, thereby making it possible to provide accurate health information of the device to the user.

In some examples, the environmental device includes various environmental devices installed outdoors, and, for example, the environmental device includes at least one type of an outdoor unit of an air conditioner, an outdoor unit of a fresh air system, and a solar energy device, and, in the example of the present application, an outdoor unit of an air conditioner, which is installed outdoors, is described as an example.

In some examples, an environmental device to be installed outdoors may be installed on a rooftop of a building, or may be installed on a bracket for a device, which is present outside the building, such as a bracket for an air conditioner, or may be installed at another certain position.

However, the method according to the example of the present application is also applied to an environmental device installed in a room, such as an indoor unit of an air conditioner, an indoor device of a fresh air system, a humidifier, or an air cleaning device.

In some examples, an environmental device that should be detected is also referred to as a target environmental device.

In some examples, inspection refers to an act of periodically inspecting a device and/or inspecting some items that have been set for the device. Alternatively, in some examples, inspection may be understood as normal inspection or detection.

At step 101, the mobile inspection device is used to collect data of the site where the environmental device is positioned.

In some examples, the mobile inspection device may be an inspection device that varies in type and that is movable, and, for example, the mobile inspection device may be a drone or an airship, or the mobile inspection device may be another facility device that is freely movable.

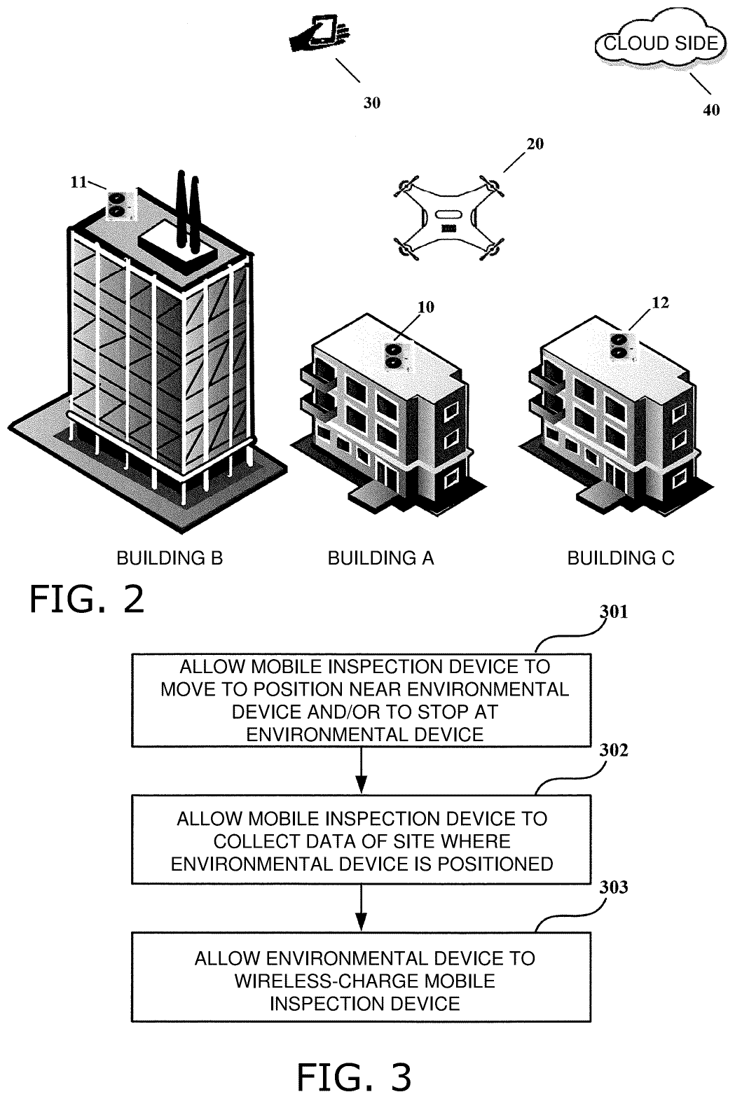

FIG. 2 is a schematic view illustrating a scene of the method for inspecting the environmental device, according to Example 1 of the present application. As illustrated in FIG. 2, for example, an air conditioner outdoor unit 10 serving as an environmental device is provided on a rooftop of a building A, and air conditioner outdoor units 11 and 12 are further provided on rooftops of neighboring buildings B and C, respectively, and a drone 20 serving as a mobile inspection device collects data of a site from at least one of the air conditioner outdoor units 10, 11, and 12.

In addition, as illustrated in FIG. 2, it is possible that the drone 20 is controlled by a control terminal 30, and, for example, remotely controlled by the control terminal 30, and/or allowed to move based on a target position or a target path that is set by the control terminal 30.

In addition, as illustrated in FIG. 2, a server 40 on a cloud side is able to perform wireless communication with the drone 20, and/or the server 40 on the cloud side is able to perform wireless communication with at least one of the air conditioner outdoor units 10, 11, and 12.

In some examples, the mobile inspection device is first allowed to move to a position near a target environmental device serving as an environmental device that should be detected or to stop at the environmental device to collect data of a site.

FIG. 3 is a schematic view illustrating a method for collecting data of the site by the mobile inspection device, according to Example 1 of the present application. As illustrated in FIG. 3, the method includes:
step 301 for allowing the mobile inspection device to move to a position near the environmental device and/or to stop at the environmental device; and
step 302 for allowing the mobile inspection device to collect data of the site where the environmental device is positioned.

In some examples, when it is possible to couple an environmental device to a network, the mobile inspection device is able to acquire information of whether or not the environmental device is operating, via a server on a cloud side, and, when it is impossible to couple an environmental device to the network, the mobile inspection device is able to fly around the environmental device to detect a situation of differences between a temperature of an exhaust air port of the environmental device and temperatures of other parts. When the temperature of the exhaust air port is higher or lower than a certain threshold value for the temperatures of the other parts, the environmental device is operating.

In some examples, the mobile inspection device is allowed to move around the environmental device to collect data at different angles and orientations to ensure integrity of the data and, for example, to ensure integrity of data of an image.

In some examples, as illustrated in FIG. 3, the method further includes
step 303 for allowing the environmental device to wireless-charge the mobile inspection device. For example, the environmental device and the mobile inspection device are each provided with a wireless charging device.

For example, the outdoor unit of the air conditioner is provided with a two dimensional code, and the mobile inspection device is charged by scanning the two dimensional code.

In this way, the environmental device wireless-charges the mobile inspection device, thereby ensuring continuous operation of the mobile inspection device and improving work efficiency.

In some examples, the mobile inspection device identifies a position of the environmental device that should be detected based on information of the position of the environmental device or information of a user address of the user using the environmental device to move to a position near the position.

When the information of the position of the environmental device or the information of the user address, which has been acquired by the mobile inspection device, is relatively accurate, and, for example, when the environmental device has a global positioning system (GPS) position-measuring function, the accurate information of its position is uploaded to the server on the cloud side. In this case, it is possible that the mobile inspection device is allowed to acquire the accurate position of the environmental device, to move directly to a position near the environmental device, and/or to stop at the environmental device to collect data.

For example, as illustrated in FIG. 2, the drone 20 is able to acquire an accurate position of the air conditioner outdoor unit 10 from the server 40 on the cloud side, to move to a position near the air conditioner outdoor unit 10 based on the accurate position, and to stop at the air conditioner outdoor unit 10.

When information of a position of the environmental device or information of a user address, which has been acquired by the mobile inspection device, is less accurate, and, for example, when the environmental device does not have a GPS position-measuring function, it is impossible to acquire accurate information of its position. When it is possible to couple the environmental device to the network, the mobile inspection device acquires information of an address of the user via the server on the cloud side, and, when it is impossible to couple the environmental device to the network, the mobile inspection device acquires information of the address, which has been registered by the user, via a database. In this case, the mobile inspection device is able to perform a search within a certain range based on the information of the position or the information of the user address, and, when a target environmental device is found, it is possible to use the position-measuring function of the mobile inspection device to upload, store, and update the accurate information of the position of the environmental device in the server on the cloud side.

For example, as illustrated in FIG. 2, the air conditioner outdoor unit 11 is not coupled to the network, and the drone 20 is impossible to acquire an accurate position of the air conditioner outdoor unit 11 from the server 40 on the cloud side. In this case, the drone 20 acquires a user address from the database and performs a search near the building A, and, when the drone 20 finds the air conditioner outdoor unit 11, is able to move to a position near the air conditioner outdoor unit 11 and to further stop at the air conditioner outdoor unit 11. Furthermore, the drone 20 may further upload the accurate position of the air conditioner outdoor unit 11 to the server 40 on the cloud side for use in a next inspection.

In addition, when it is impossible to acquire information of a position of an environmental device or information of an address, it is possible to acquire a building information model (BIM) at a position where the environmental device is present, and, after the position of the environmental device is found from the BIM model, it is possible to move to and confirm the position.

In this way, for a situation where environmental devices differ from each other, the mobile inspection device is able to smoothly reach a position where a target environmental device is present to carry out a task, thereby improving reliability and universality of the method.

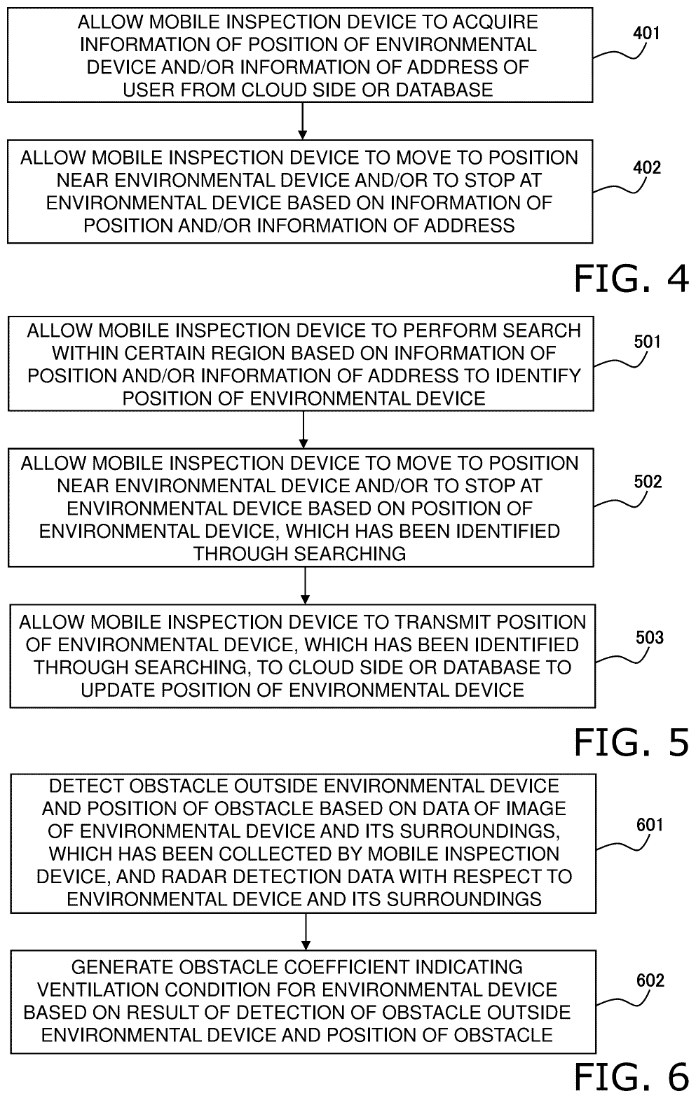

FIG. 4 is a schematic view illustrating a method for achieving step 301, according to Example 1 of the present application. As illustrated in FIG. 4, the method includes:
step 401 for allowing the mobile inspection device to acquire information of a position of the environmental device and/or information of an address of the user from the cloud side or a database; and
step 402 for allowing the mobile inspection device to move to a position near the environmental device and/or to stop at the environmental device based on the information of the position and/or the information of the address.

FIG. 5 is a schematic view illustrating another method for achieving step 301, according to Example 1 of the present application. As illustrated in FIG. 5, the method includes:
step 501 for allowing the mobile inspection device to perform a search within a certain region based on the information of the position and/or the information of the address to identify a position of the environmental device; and
step 502 for allowing the mobile inspection device to move to a position near the environmental device and/or to stop at the environmental device based on the position of the environmental device, which has been identified through the searching.

In some examples, as illustrated in FIG. 5, the method further includes
step 503 for allowing the mobile inspection device to transmit the position of the environmental device, which has been identified through the searching, to the cloud side or the database to update the position of the environmental device.

In this way, the mobile inspection device transmits the accurate position of the searched environmental device to the cloud side or the database, easing later inspections for the environmental device.

In some examples, the data collected by the mobile inspection device includes at least one of data of an image of the environmental device and its surroundings, radar detection data with respect to the environmental device and its surroundings, data of vibration of the environmental device, data of sound of the environmental device, data of an air quantity of the environmental device, and data of an infrared image of the environmental device and its surroundings.

Correspondingly, the mobile inspection device includes a hardware device capable of collecting such data as described above, and, for example, the mobile inspection device includes at least one of an imaging module, an infrared imaging module, a vibration sensor, a directional sound sensor, a radio detecting and ranging (radar), and an air quantity sensor.

At step 102, information of changes in the site where the environmental device is positioned is generated based on the data collected by the mobile inspection device. Accordingly and correspondingly, in some examples, the information of changes includes at least one of a ventilation condition for the environmental device, a degree of cleanliness of the environmental device, information of shielding of the environmental device, a drain state, a quantity of exhaust air of the environmental device, an installation state of the environmental device, an ignition risk of the environmental device, and a refrigerant leakage risk.

In some examples, it is possible to input the data collected by the mobile inspection device into a model to output information of changes in the site where the environmental device is positioned.

In some examples, for pieces of data that are different in type from each other, it is possible to input the pieces of data that are different in type from each other and that have been collected by the mobile inspection device into corresponding models that are different in type from each other, respectively, to output corresponding pieces of information of changes, respectively.

In this way, directly acquiring information of changes through a model having undergone training makes it possible to efficiently perform processing and to acquire an accurate result.

In some examples, the mobile inspection device transmits the collected data to the server on the cloud side, and, thereby, the server generates information of changes in the site where the environmental device is positioned based on the collected data. That is, step 102 may be executed by the server on the cloud side.

In addition, when there may be a deteriorated communication situation between the mobile inspection device and the server on the cloud side, the mobile inspection device may store collected data in the mobile inspection device in advance, and, when the communication situation is improved, the mobile inspection device may transmit the collected data to the server on the cloud side. In this way, application in various network states is achieved, making it possible to ensure smooth progress of inspection stages.

Various collected data and various generated information of changes will now be described herein in detail.

Generation of a ventilation condition for the environmental device in information of changes will now first be described.

FIG. 6 is a schematic view illustrating a method for generating a ventilation condition, according to Example 1 of the present application. As illustrated in FIG. 6, the method includes:
step 601 for detecting an obstacle outside the environmental device and a position of the obstacle based on data of an image of the environmental device and its surroundings, which has been collected by the mobile inspection device, and radar detection data with respect to the environmental device and its surroundings; and
step 602 for generating an obstacle coefficient indicating a ventilation condition for the environmental device based on a result of the detection of the obstacle outside the environmental device and the position of the obstacle.

In some examples, the obstacle includes a branch, a leaf, a foreign object, and another nearby environmental device outside the environmental device.

Since an obstacle outside an environmental device greatly affects a health state of the environmental device, an obstacle coefficient generated based on a result of detection of the obstacle makes it possible to further improve accuracy of estimating a health state parameter of the environmental device.

At step 602, it is possible to input the result of the detection of the obstacle outside the environmental device and the position of the obstacle into a first model having undergone training to output an obstacle coefficient.

In some examples, the first model may be a model based on a neural network, and is acquired through training based on various training methods.

Next, generation of a degree of cleanliness of the environmental device in information of changes will now be described.

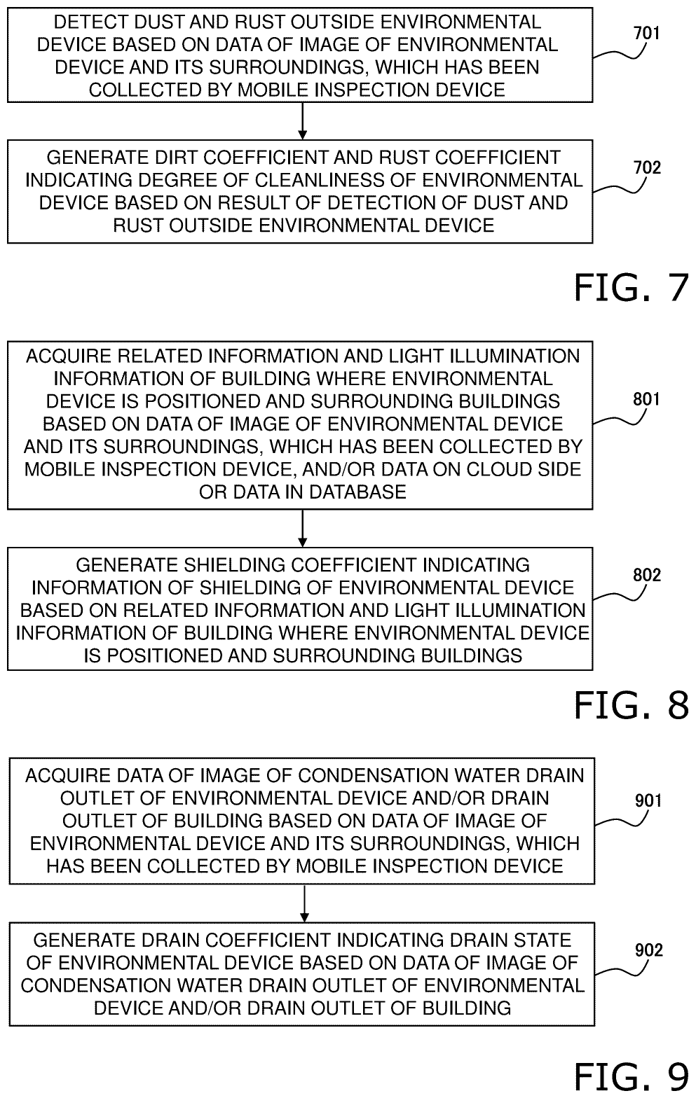

FIG. 7 is a schematic view illustrating a method for generating a degree of cleanliness, according to Example 1 of the present application. As illustrated in FIG. 7, the method includes:
step 701 for detecting dust and rust outside the environmental device based on data of an image of the environmental device and its surroundings, which has been collected by the mobile inspection device; and
step 702 for generating a dirt coefficient and a rust coefficient indicating a degree of cleanliness of the environmental device based on a result of the detection of the dust and rust outside the environmental device.

At step 701, it is possible to detect dust and rust in the data of the image based on an image recognition method.

At step 702, it is possible to input the result of the detection of the dust and rust outside the environmental device into a second model having undergone training to output a dirt coefficient and a rust coefficient.

In some examples, the second model may be a model based on a neural network, and is acquired through training based on various training methods.

Dust and iron rust on a surface of an environmental device are likely to cause the environmental device to be corroded to affect performance such as heat dissipation and waterproofing of the device, greatly affecting a health state of the environmental device. Therefore, a dirt coefficient and a rust coefficient generated based on a result of detection of dust and rust make it possible to further improve accuracy of estimating a health state parameter of the environmental device.

Next, generation of information of shielding of the environmental device in information of changes will now be described.

FIG. 8 is a schematic view illustrating a method for generating information of shielding, according to Example 1 of the present application. As illustrated in FIG. 8, the method includes:
step 801 for acquiring related information and light illumination information of a building where the environmental device is positioned and surrounding buildings based on data of an image of the environmental device and its surroundings, which has been collected by the mobile inspection device, and/or data on the cloud side or data in the database; and
step 802 for generating a shielding coefficient indicating information of shielding of the environmental device based on the related information and the light illumination information of the building where the environmental device is positioned and the surrounding buildings.

For example, as illustrated in FIG. 2, when a target environmental device that should be detected is the air conditioner outdoor unit 10, it is possible to acquire information of the building A and the surrounding buildings B and C, such as a floor height, an area, and a position, and to further acquire light illumination information of the building A, such as a position of the building A, and geographical information of a city where the building A is positioned.

At step 802, it is possible to input the related information and the light illumination information of the building where the environmental device is positioned and the surrounding buildings into a third model having undergone training to output a shielding coefficient.

In some examples, the third model may be a model based on a neural network, and is acquired through training based on various training methods.

In this way, since illumination of light tends to accelerate deterioration of a device due to aging, taking a shielding coefficient into consideration makes it possible to further improve accuracy of estimating a health state parameter of the environmental device.

Next, generation of a drain state of the environmental device in information of changes will now be described.

FIG. 9 is a schematic view illustrating a method for generating a drain state, according to Example 1 of the present application. As illustrated in FIG. 9, the method includes:
step 901 for acquiring data of an image of a condensation water drain outlet of the environmental device and/or a drain outlet of the building based on data of an image of the environmental device and its surroundings, which has been collected by the mobile inspection device; and
step 902 for generating a drain coefficient indicating a drain state of the environmental device based on the data of the image of the condensation water drain outlet of the environmental device and/or the drain outlet of the building.

In some examples, the condensation water drain outlet of the environmental device is, for example, a condensation water drain outlet of an outdoor unit of an air conditioner, and the drain outlet of the building is, for example, a drain outlet on a rooftop on which the environmental device is installed.

At step 902, it is possible to input the data of the image of the condensation water drain outlet of the environmental device and/or the drain outlet of the building into a fourth model having undergone training to output a drain coefficient.

In some examples, the fourth model may be a model based on a neural network, and is acquired through training based on various training methods.

In this way, since there is a possibility that accumulated water causes corrosion on the device and deterioration of performance due to aging, taking a drain coefficient into consideration makes it possible to further improve accuracy of estimating a health state parameter of the environmental device.

Next, generation of a quantity of exhaust air of the environmental device in information of changes will now be described.

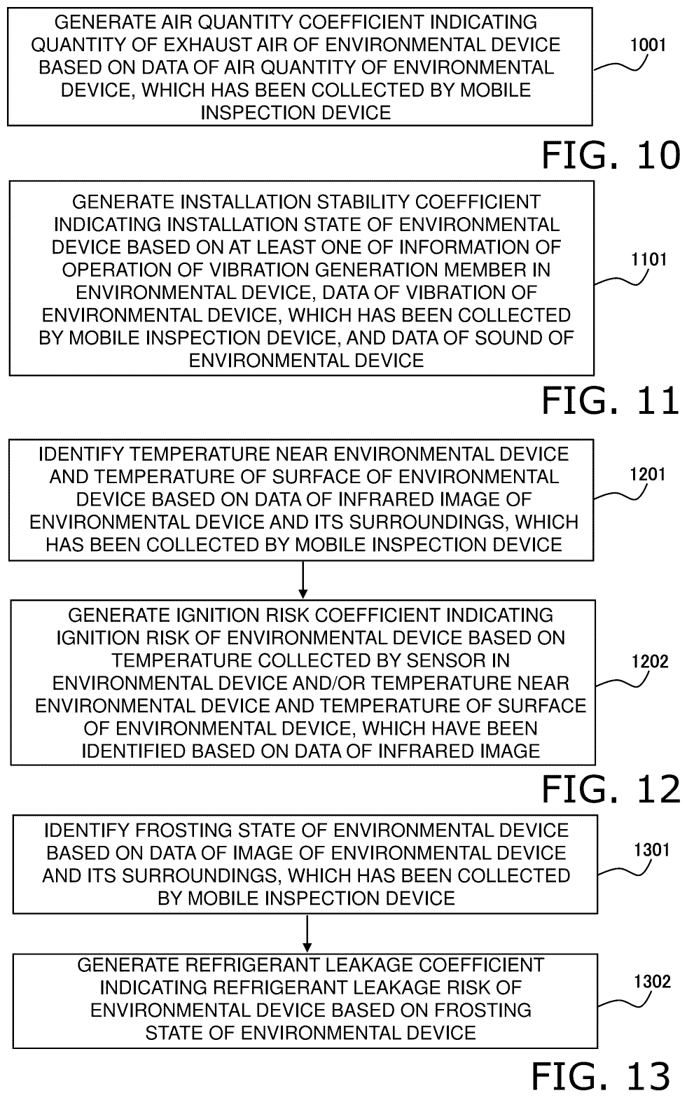

FIG. 10 is a schematic view illustrating a method for generating a quantity of exhaust air, according to Example 1 of the present application. As illustrated in FIG. 10, the method includes
step 1001 for generating an air quantity coefficient indicating a quantity of exhaust air of the environmental device based on data of an air quantity of the environmental device, which has been collected by the mobile inspection device.

In some examples, the data of the air quantity is, for example, data of air quantities at an intake air port and an exhaust air port of the environmental device.

For example, data of an air quantity is acquired from a degree of acceleration of a drone that is present near each of the intake air port and the exhaust air port.

At step 1001, it is possible to input the data of the air quantity of the environmental device into a fifth model having undergone training to output an air quantity coefficient.

In some examples, the fifth model may be a model based on a neural network, and is acquired through training based on various training methods.

In this way, since an air quantity affects performance and deterioration due to aging of the device to some extent, taking an air quantity coefficient into consideration makes it possible to further improve accuracy of estimating a health state parameter of the environmental device.

Next, generation of an installation state of the environmental device in information of changes will now be described.

FIG. 11 is a schematic view illustrating a method for generating an installation state, according to Example 1 of the present application. As illustrated in FIG. 11, the method includes
step 1101 for generating an installation stability coefficient indicating an installation state of the environmental device based on at least one of information of operation of a vibration generation member in the environmental device, data of vibration of the environmental device, which has been collected by the mobile inspection device, and data of sound of the environmental device.

In some examples, when the environmental device operates, the mobile inspection device detects information of operation of the vibration generation member in the environmental device, data of vibration of the environmental device, which has been collected by the mobile inspection device, and data of sound of the environmental device.

In some examples, the drone serving as the mobile inspection device stops at the environmental device, turns off a motor, detects data of vibration of the environmental device with a vibration sensor, and detects data of sound with a directional microphone.

In some examples, it is possible that the vibration generation member in the environmental device includes a motor, a compressor, and the like. For example, operation of the member includes a shift position and a number of rotations, for example, of the member.

At step 1101, it is possible to input at least one of the information of operation of the vibration generation member in the environmental device, the data of vibration of the environmental device, which has been collected by the mobile inspection device, and the data of sound of the environmental device into a sixth model having undergone training to output an installation stability coefficient.

In some examples, the sixth model may be a model based on a neural network, and is acquired through training based on various training methods.

In some examples, when it is possible to acquire information of operation of the vibration generation member in the environmental device, and, for example, when it is possible to couple the environmental device to the network and related information is uploaded to the server on the cloud side, the information of operation of the vibration generation member in the environmental device, the data of vibration of the environmental device, and the data of sound of the environmental device are inputted into the sixth model to acquire an installation stability coefficient.

In some examples, when it is impossible to acquire information of operation of the vibration generation member in the environmental device, and, for example, when it is impossible to couple the environmental device to the network, the data of vibration of the environmental device, which has been collected by the mobile inspection device, and the data of sound of the environmental device are inputted into the sixth model to acquire an installation stability coefficient.

In this way, since installation stability of the device affects performance and deterioration due to aging of the device to some extent, taking an installation stability coefficient into consideration makes it possible to further improve accuracy of estimating a health state parameter of the environmental device.

Next, generation of an ignition risk in information of changes will now be be described.

FIG. 12 is a schematic view illustrating a method for generating an ignition risk, according to Example 1 of the present application. As illustrated in FIG. 12, the method includes:
step 1201 for identifying a temperature near the environmental device and a temperature of the surface of the environmental device based on data of an infrared image of the environmental device and its surroundings, which has been collected by the mobile inspection device; and
step 1202 for generating an ignition risk coefficient indicating an ignition risk of the environmental device based on a temperature collected by a sensor in the environmental device and/or the temperature near the environmental device and the temperature of the surface of the environmental device, which have been identified based on the data of the infrared image.

At step 1202, it is possible to input the collected temperature or identified temperature into a seventh model having undergone training to output an ignition risk coefficient.

In some examples, the seventh model may be a model based on a neural network, and is acquired through training based on various training methods.

In this way, since a temperature affects performance and deterioration due to aging of the device to some extent, taking an ignition risk coefficient into consideration makes it possible to further improve accuracy of estimating a health state parameter of the environmental device.

In addition, in some examples, an ignition risk report may be generated based on an ignition risk coefficient and may be push-delivered to the user. In this way, the user is able to timely know a potential fire risk and to take preventive measures in advance.

Next, generation of a refrigerant leakage risk in information of changes will now be described.

FIG. 13 is a schematic view illustrating a method for generating a refrigerant leakage risk, according to Example 1 of the present invention. As illustrated in FIG. 13, the method includes:
step 1301 for identifying a frosting state of the environmental device based on data of an image of the environmental device and its surroundings, which has been collected by the mobile inspection device; and
step 1302 for generating a refrigerant leakage coefficient indicating a refrigerant leakage risk of the environmental device based on the frosting state of the environmental device.

At step 1302, it is possible to input the frosting state of the environmental device into an eighth model having undergone training to output a refrigerant leakage coefficient.

In some examples, the eighth model may be a model based on a neural network, and is acquired through training based on various training methods.

In this way, since a refrigerant leakage affects performance and deterioration due to aging of the device to some extent, taking a refrigerant leakage coefficient into consideration makes it possible to further improve accuracy of estimating a health state parameter of the environmental device.

The method for generating, at step 102, information of changes, which includes at least one of a ventilation condition for the environmental device, a degree of cleanliness of the environmental device, information of shielding of the environmental device, a drain state, a quantity of exhaust air of the environmental device, an installation state of the environmental device, an ignition risk of the environmental device, and a refrigerant leakage risk, has been specifically described above.

In some examples, it is possible to identify which one piece of information of changes or pieces of information of changes described above is or are to be generated in accordance with an actual situation based on data collectable by the mobile inspection device, based on a degree of influence of information of changes on estimation of a health state of the device, or based on a requirement with respect to estimation accuracy, for example.

In some examples, steps for generating a plurality of pieces of information of changes may be performed previously or later or simultaneously, and an order of generating different pieces of information of changes is not limited in the example of the present application.

At step 103, operation data of the environmental device and information of an initial operation time of the environmental device are acquired.

In some examples, steps 102 and 103 may be executed sequentially or may be executed simultaneously, and an order of executing steps 102 and 103 is not limited in the example of the present application.

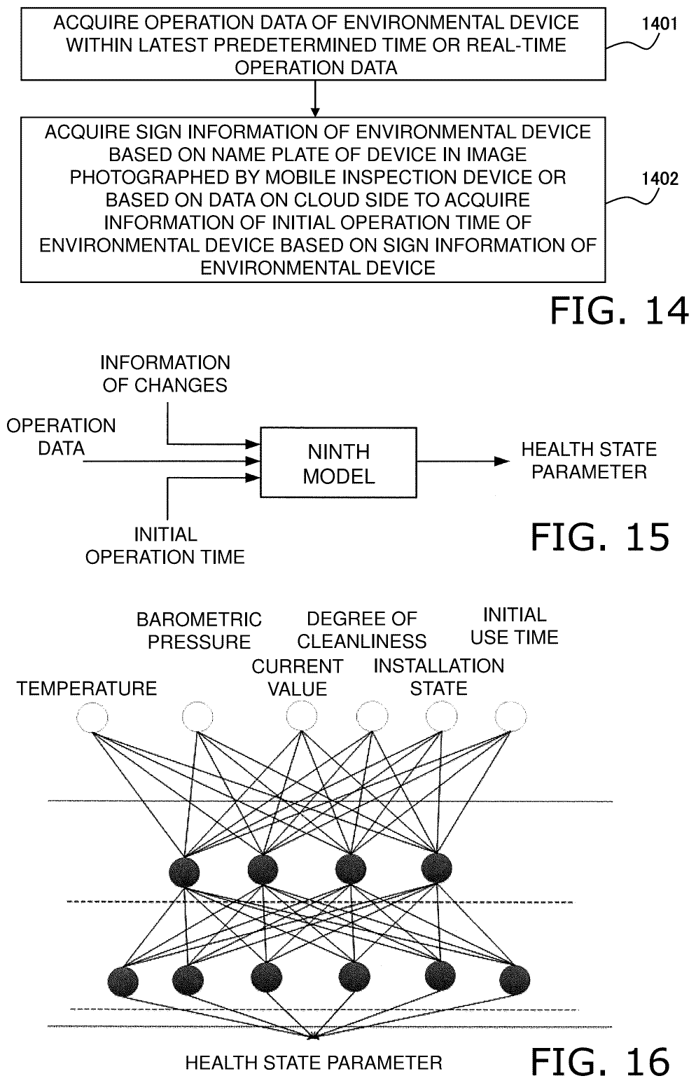

FIG. 14 is a schematic view illustrating a method for achieving step 103, according to Example 1 of the present application. As illustrated in FIG. 14, the method includes:
step 1401 for acquiring operation data of the environmental device within a latest predetermined time or real-time operation data; and
step 1402 for acquiring sign information of the environmental device based on a name plate of the device in an image photographed by the mobile inspection device or based on data on the cloud side to acquire information of an initial operation time of the environmental device based on the sign information of the environmental device.

In some examples, steps 1401 and 1402 may be executed sequentially or simultaneously, and an order of executing steps 1401 and 1402 is not limited in the example of the present application.

In some examples, for example, operation data of the environmental device for last 30 minutes is acquired, or operation data is acquired in a real-time manner.

In some examples, it is possible that operation data of the environmental device includes various operation data. For example, for an outdoor unit of an air conditioner, it is possible that its operation data includes a temperature, barometric pressure, an operation current value, and a voltage value, and the like.

For example, the server on the cloud side acquires operation data of the environmental device.

In some examples, the server on the cloud side identifies an identification (ID) of the environmental device based on a name plate of the device to acquire an initial operation time of the environmental device.

At step 104, a health state parameter of the environmental device is identified based on the information of changes in the site where the environmental device is positioned, the operation data of the environmental device, and the information of the initial operation time of the environmental device.

In some examples, it is possible to use a model having undergone training to acquire a health state parameter, and it is possible to allow the model to undergo training with various training methods.

For example, the information of changes in the site where the environmental device is positioned, the operation data of the environmental device, and the information of the initial operation time of the environmental device are inputted into a ninth model to calculate and output a health state parameter of the environmental device.

In this way, it is possible to acquire an accurate result of estimation.

FIG. 15 is a schematic view illustrating how to use the ninth model, according to Example 1 of the present application. As illustrated in FIG. 15, the information of changes in the site where the environmental device is positioned, the operation data of the environmental device, and the information of the initial operation time of the environmental device are inputted into the ninth model to output a health state parameter of the environmental device.

In some examples, the ninth model is a model based on a fully connected neural network. However, a model based on another network structure may be used in the example of the present application.

FIG. 16 is a schematic view illustrating a network structure of the ninth model, according to Example 1 of the present application. As illustrated in FIG. 16, the operation data such as a temperature, pressure, and a current value of the environmental device, a degree of cleanliness, an installation state, and an initial use time of the environmental device are inputted into the fully connected neural network to output a health state parameter of the environmental device.

In some examples, no model may be allowed to undergo training, and, for example, a health state parameter of the environmental device may be acquired with a table lookup method.

For example, a lookup table method is used to identify a health state parameter of the environmental device based on the information of changes in the site where the environmental device is positioned, the operation data of the environmental device, and the information of the initial operation time of the environmental device. That is, a matching table between these pieces of information and health state parameters is created in advance, and a direct search is performed on the table during a time of use to acquire a corresponding parameter.

In this way, it is possible to easily acquire a health state parameter.

In some examples, a health state parameter of the environmental device may include one or more parameters.

For example, a health state parameter of the environmental device includes at least one of a degree of deterioration due to aging and a depreciation rate of the environmental device.

In some examples, it is possible to express a degree of deterioration due to aging or a depreciation rate in percentage. For example, a degree of deterioration due to aging is 50%, or a depreciation rate is 50%.

In this way, the user is able to intuitively know present value of the environmental device, and to determine a decision such as servicing or replacement in advance.

In some examples, as illustrated in FIG. 1, the method further includes
step 105 for providing a servicing or replacement policy for the environmental device to the user based on the identified health state parameter of the environmental device and a reference value of the health state parameter. Step 105 is an optional step, and is indicated by a dashed-line box in FIG. 1.

In this way, it is possible to provide a reasonable advice to the user to further improve experience of the user.

In some examples, it is possible to acquire a reference value of the health state parameter by performing a calculation based on an initial health state parameter, a use time length, an aging deterioration coefficient, and a cleanliness reduction rate of the environmental device. For example, it is possible to acquire a degree of deterioration due to aging by performing a calculation in accordance with Math. 1 described below.

$$p = {p}_{0} + a * log ( b * y + d ) \qquad Math . 1$$

Where p is degree of deterioration due to aging, p₀ is initial degree of deterioration due to aging, a is aging deterioration coefficient, b is cleanliness reduction rate, and d is rapid aging deterioration coefficient.

In some examples, the replacement policy for the environmental device includes a visual relationship between exchange value of the device and a health state parameter.

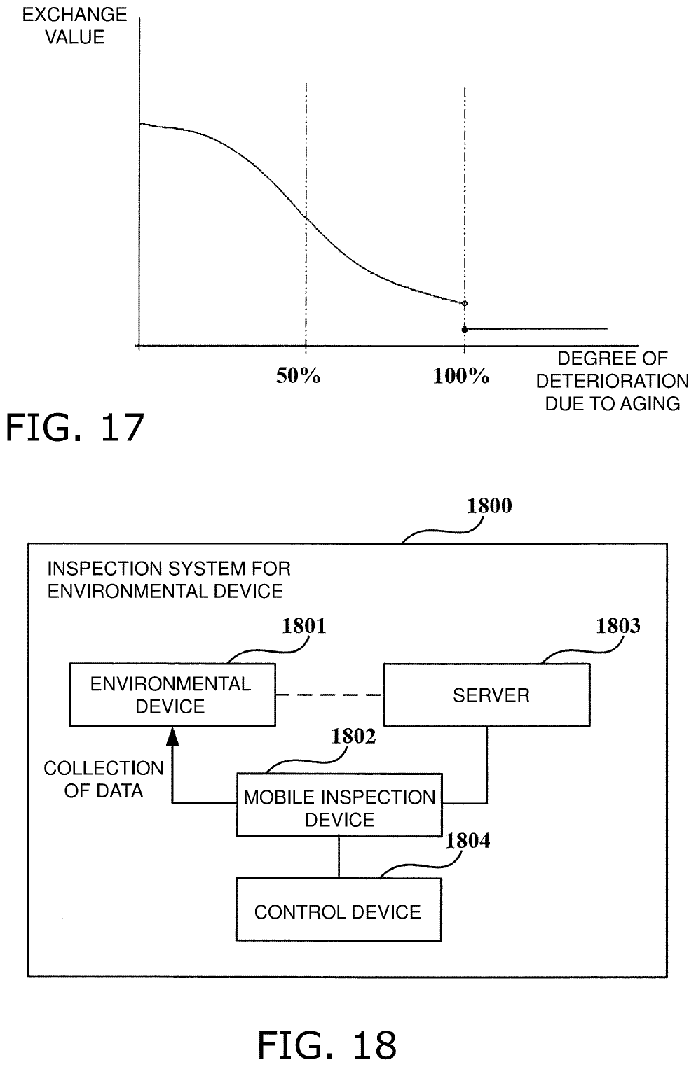

FIG. 17 is a schematic view illustrating a relationship between the exchange value of the device and a degree of deterioration due to aging, according to Example 1 of the present application. As illustrated in FIG. 17, after the degree of deterioration due to aging reaches 50%, the exchange value rapidly lowers, and, after the degree of deterioration due to aging reaches 100%, the exchange value stays at an extremely low level.

In this way, the diagram of the visual relationship allows the user to intuitively know the relationship between the exchange value and the degree of deterioration due to aging, making it possible to take reasonable replacement measures at an early stage to further improve experience of the user.

For example, it is possible to calculate the exchange value in accordance with Math. 2 described below.

$$y exchange value = \{ \begin{matrix}{f}_{1} ( p ) , & p \geq 50 \% \\ {f}_{2} ( p ) , & 50 \% < p < 100 \% \\ {y}_{0} * {b}_{0} , & p \geq 100 \%\end{matrix} \qquad Math . 2$$

Where p is degree of deterioration due to aging, y₀ is original value of the environmental device, and b₀ is value when the device is treated to be discarded.

In some examples, as illustrated in FIG. 1, the method further includes
step 106 for generating and transmitting an inspection report to the user based on the identified health state parameter of the environmental device. Step 106 is an optional step, and is indicated by a dashed-line box in FIG. 1.

In this way, the user is able to comprehensively know specific information of inspection, further improving experience of the user.

In some examples, when there is a large amount of information of abnormalities or there is occurrence of information of abnormality of a high risk level, information of an alarm is directly push-delivered to the user.

In some examples, as illustrated in FIG. 1, the method further includes
step 107 for using the mobile inspection device to perform a cleaning operation on the environmental device to transmit the inspection report in which the cleaning operation is included to the user. Step 107 is an optional step, and is indicated by a dashed-line box in FIG. 1.

For example, the mobile inspection device may be used to blow out foreign substances and dust outside the environmental device.

In this way, it is possible to fully utilize the mobile inspection device to achieve a cleaning function simultaneously during inspection, thereby further improving experience of the user.

In some examples, as illustrated in FIG. 1, the method further includes
step 108 for selecting at least one environmental device as a charging station from the environmental device serving as the inspection target and other environmental devices on a moving path for the mobile inspection device to charge the mobile inspection device. Step 108 is an optional step, and is indicated by a dashed-line box in FIG. 1.

In this way, it is possible to fully utilize each of the environmental devices on the moving path as a charging station, making it possible to ensure work continuity and work efficiency of the mobile inspection device.

For example, it is possible to identify a moving path in accordance with a present direction of wind, and to select an optimal environmental device as a charging station.

In some examples, the environmental device charges the mobile inspection device via a battery.

In some examples, a two dimensional code is printed on the environmental device, and the mobile inspection device is charged by scanning the two dimensional code.

In some examples, it is possible to charge the mobile inspection device promptly across two environmental devices. For example, a mobile inspection device may have a plurality of NFCs to make it possible to register a plurality of devices.

In some examples, the mobile inspection device is able to further perform an operation such as a payment for the charging via the control terminal.

Since, as can be seen from the example described above, a mobile inspection device is used to collect data of an environmental device, information of changes in a site of the device is generated based on the data, and a health state parameter of the environmental device is identified based on the information of changes in the site of the device, operation data of the device, and an initial operation time, a user is able to timely know a health state of the environmental device, and thereby able to determine in advance a decision for maintenance, servicing, and replacement, for example, making it possible to fully utilize value of the environmental device to improve use experience of the user.

Furthermore, since, when a health state parameter of the environmental device is to be identified, information of changes, which has been generated from data collected in the site, and information such as operation data and an operation time of the device are combined with each other, various factors affecting the health state of the device are comprehensively taken into consideration, and accuracy of a result of estimation is improved, thereby making it possible to provide accurate health information of the device to the user.

### Example 2

Example 2 of the present invention provides an inspection system for an environmental device, the inspection system for the environmental device corresponds to the method for inspecting the environmental device, as described in Example 1, for specific implementation of which it is possible to refer to the implementation of the method as described in Example 1, and identical or related contents will not be described in a repeated manner.

FIG. 18 is a schematic view illustrating the inspection system for the environmental device, according to Example 2 of the present invention, and, as illustrated in FIG. 18, an inspection system 1800 for an environmental device includes an environmental device 1801 serving as an inspection target, a mobile inspection device 1802, and a server 1803 on a cloud side.

The mobile inspection device 1802 is allowed to move to a position near the environmental device 1801 and/or to stop at the environmental device 1801, to collect data of a site where the environmental device 1801 is positioned, and to transmit the data to the server 1803.

The server 1803 receives the data transmitted by the mobile inspection device 1802 to generate information of changes in the site where the environmental device 1801 is positioned based on the data, and the server 1803 acquires operation data of the environmental device 1801 and information of an initial operation time of the environmental device 1801 from the environmental device 1801 or the cloud side to further identify a health state parameter of the environmental device 1801 based on the information of changes in the site where the environmental device 1801 is positioned, the operation data of the environmental device 1801, and the information of the initial operation time of the environmental device 1801.

In some examples, the server 1803 further provides a servicing or update policy for the environmental device to the user based on the identified health state parameter of the environmental device and a reference value of the health state parameter.

In some examples, the server 1803 further generates and transmits an inspection report to the user based on the identified health state parameter of the environmental device.

In some examples, it is possible that the environmental device 1801 is to be coupled to a network, and thereby to be communicatively coupled to the server 1803, and, in some other examples, it is impossible that the environmental device 1801 is to be coupled to the network, and thereby to be coupled to the server 1803.

In some examples, as illustrated in FIG. 18, the system further includes
a control device 1804 that controls movement, operation, and charging of the mobile inspection device 1802.

In addition, the control device 1804 is able to further perform processing such as a payment.

In some examples, the control device 1804 selects at least one environmental device as a charging station from the environmental device 1801 serving as the inspection target and other environmental devices on a moving path for the mobile inspection device 1802 to charge the mobile inspection device.

In some examples, the environmental device includes an outdoor unit of an air conditioner.

In some examples, the environmental device further includes a charging device provided on the outdoor unit of the air conditioner.

In some examples, the outdoor unit of the air conditioner is provided with a two dimensional code, and, as the mobile inspection device scans the two dimensional code, the charging device on the outdoor unit of the air conditioner charges the mobile inspection device.

In some examples, the mobile inspection device is a drone or an airship.

In some examples, for achieving the functions of the devices described above, it is possible to refer to the contents of related steps in Example 1, which will not be described in a repeated manner.

Since, as can be seen from the example described above, a mobile inspection device is used to collect data of an environmental device, information of changes in a site of the device is generated based on the data, and a health state parameter of the environmental device is identified based on the information of changes in the site of the device, operation data of the device, and an initial operation time, a user is able to timely know a health state of the environmental device, and thereby able to determine in advance a decision for maintenance, servicing, and replacement, for example, making it possible to fully utilize value of the environmental device to improve use experience of the user.

Furthermore, since, when a health state parameter of the environmental device is to be identified, information of changes, which has been generated from data collected in the site, and information such as operation data and an operation time of the device are combined with each other, various factors affecting the health state of the device are comprehensively taken into consideration, and accuracy of a result of estimation is improved, thereby making it possible to provide accurate health information of the device to the user.

### Example 3

Example 3 of the present invention provides a mobile inspection device, and, for specific contents of the mobile inspection device, it is possible to refer to the description of the method in Example 1 and the system in Example 2, and identical or related contents will not be described in a repeated manner.

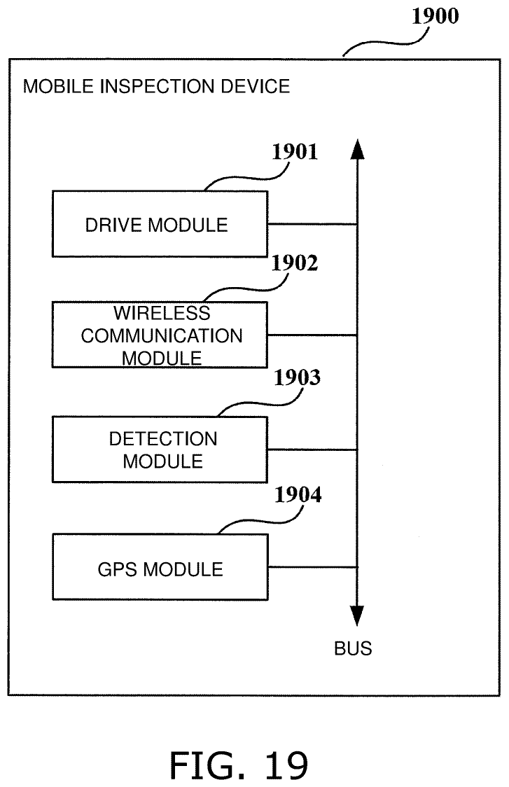

FIG. 19 is a schematic view illustrating a mobile inspection device according to Example 3 of the present invention, and, as illustrated in FIG. 19, the mobile inspection device 1900 includes:
a drive module 1901 that supplies a driving force for allowing the mobile inspection device to move;
a wireless communication module 1902 that performs wireless communication with at least one of a control device for the mobile inspection device, an environmental device, and a server on a cloud side;
a detection module 1903 including at least one of an imaging module, an infrared imaging module, a vibration sensor, a directional sound sensor, a radio detecting and ranging (radar), and an air quantity sensor; and
a global positioning system (GPS) module 1904 that identifies a position of the mobile inspection device.

In some examples, the wireless communication module includes at least one of a Bluetooth (registered trademark) module, a near field communication (NFC) module, and a 2.4G module.

In some examples, the mobile inspection device is a drone or an airship.

Since, as can be seen from the example described above, a mobile inspection device is used to collect data of an environmental device, information of changes in a site of the device is generated based on the data, and a health state parameter of the environmental device is identified based on the information of changes in the site of the device, operation data of the device, and an initial operation time, a user is able to timely know a health state of the environmental device, and thereby able to determine in advance a decision for maintenance, servicing, and replacement, for example, making it possible to fully utilize value of the environmental device to improve use experience of the user.

Furthermore, since, when a health state parameter of the environmental device is to be identified, information of changes, which has been generated from data collected in the site, and information such as operation data and an operation time of the device are combined with each other, various factors affecting the health state of the device are comprehensively taken into consideration, and accuracy of a result of estimation is improved, thereby making it possible to provide accurate health information of the device to the user.

The device and method according to the examples of the present invention described above may be achieved by means of hardware, or may be achieved by means of a combination of hardware and software. The present invention relates to a computer-readable program that makes it possible, when executed by a logic component, to cause the logic component to achieve the device or component described above, or to cause the logic component to achieve the various methods or things described above.

The examples of the present invention further relate to a storage medium for storing the program described above, such as a hard disk, a magnetic disk, an optical disc, a digital versatile disc (DVD), a flash memory, and the like.

It should be noted that limitation in the steps according to the present solution does not limit an order of the steps on the premise of not affecting the implementation of the specific solution, and those written before may be executed first, or may be executed later, or may be executed simultaneously, and, when it is possible to implement the present solution, all of those should be considered to belong to the protection scope of the present application.

Although the present invention has been described with reference to specific embodiments, those skilled in the art will appreciate that these descriptions are only exemplary and are not intended to limit the protection scope of the present invention. A person skilled in the art is able to make various modifications and corrections to the present invention based on the spirit and principle of the present invention, and these modifications and corrections also fall within the scope of the present invention.

### Other

With rapidly developing social economy and rapidly advancing urbanization and industrialization, environmental devices such as air conditioners have been widely applied.

With extending durable years, an environmental device gradually deteriorates due to aging. Currently and generally, only when there is an abnormality in an environmental device or there is a deteriorated use situation, a user requests an inspection, and a servicing person visits his or her house to inspect the device.

In addition, the servicing person may periodically visit the house to perform an inspection service, and, during an inspection, the servicing person collects operation data of the environmental device, inspects an operation situation of the environmental device, and estimates a degree of deterioration due to aging based on the operation data of the environmental device, for example, to lower a probability of occurrence of an initial abnormality in the environmental device to some extent.

It should be noted that the above description with respect to the technical background is merely provided to clearly and completely describe technical solutions according to the present invention and to ease understanding by those skilled in the art. Even only when these solutions are described in the background art part pertaining to the present invention, it is not considered that the technical solutions described above are known to those skilled in the art.

However, although, in the conventional method described above, there is a possibility that irreversible damage has occurred in an environmental device when a user has reported that there is an abnormality in the environmental device or there is a deteriorated use situation, the servicing person generally determines an operation state and a degree of deterioration due to aging, for example, of the environmental device from the operation data, in the conventional inspection method, and, since the method depends on experience of the servicing person and takes only the operation data into consideration when a degree of deterioration due to aging of the environmental device is to be estimated, a result of estimation may not be accurate.

In fact, for an environmental device, or for an environmental device installed outdoors, environmental factors in a site where the environmental device is positioned also greatly affect deterioration due to aging of the device, and factors such as washing due to rainwater, a state of a drain outlet on a roof, whether the drain outlet is blocked or not, effects of a layout of a peripheral device on ventilation of the environmental device, rust, dirt, or installation positions of solar panels and devices of other manufacturers covering the environmental device also greatly affect deterioration due to aging of the environmental device. However, in the conventional method, no dynamic factors in a site where these devices are positioned are taken into consideration.

In addition, in the conventional method described above, the user is impossible to timely know information such as a degree of deterioration due to aging of the environmental device, making it impossible to take measures in advance. That is, there is no request for servicing, maintenance, or replacement for the device until it is impossible to normally use the device, which lowers value of the device and leads to wasting, negatively affecting experience of the user.

To solve at least one of those issues described above, an example of the present invention provides a method, a device, and a system for inspecting an environmental device. It is thus possible to provide an accurate result of estimation of a health state of the environmental device, allowing the user to timely know the health state of the environmental device.

According to a first aspect of an example of the present invention, there is provided a method for inspecting an environmental device, including: using a mobile inspection device to collect data of a site where the environmental device is positioned; generating information of changes in the site where the environmental device is positioned based on the data collected by the mobile inspection device; acquiring operation data of the environmental device and information of an initial operation time of the environmental device; and identifying a health state parameter of the environmental device based on the information of changes in the site where the environmental device is positioned, the operation data of the environmental device, and the information of the initial operation time of the environmental device.

According to a second aspect of the example of the present invention, there is provided an inspection system for an environmental device, including: the environmental device serving as an inspection target; a mobile inspection device; and a server on a cloud side, in which the mobile inspection device is allowed to move to a position near the environmental device and/or to stop at the environmental device, to collect data of a site where the environmental device is positioned, and to transmit the data to the server, and the server receives the data transmitted by the mobile inspection device to generate information of changes in the site where the environmental device is positioned based on the data, and the server acquires operation data of the environmental device and information of an initial operation time of the environmental device from the environmental device or the cloud side to further identify a health state parameter of the environmental device based on the information of changes in the site where the environmental device is positioned, the operation data of the environmental device, and the information of the initial operation time of the environmental device.

According to a third aspect of the example of the present invention, there is provided a mobile inspection device including: a drive module that supplies a driving force for allowing the mobile inspection device to move; a wireless communication module that performs wireless communication with at least one of a control device for the mobile inspection device, an environmental device, and a server on a cloud side; a detection module including at least one of an imaging module, an infrared imaging module, a vibration sensor, a directional sound sensor, a radar, and an air quantity sensor; and a global positioning system (GPS) module that identifies a position of the mobile inspection device.

One of beneficial effects of the example of the present invention is that, since a mobile inspection device is used to collect data of an environmental device, information of changes in a site of the device is generated based on the data, and a health state parameter of the environmental device is identified based on the information of changes in the site of the device, operation data of the device, and an initial operation time, a user is able to timely know a health state of the environmental device, and thereby able to determine in advance a decision for maintenance, servicing, and replacement, for example, making it possible to fully utilize value of the environmental device to improve use experience of the user.

Furthermore, since, when a health state parameter of the environmental device is to be identified, information of changes, which has been generated from data collected in the site, and information such as operation data and an operation time of the device are combined with each other, various factors affecting the health state of the device are comprehensively taken into consideration, and accuracy of a result of estimation is improved, thereby making it possible to provide accurate health information of the device to the user.

It is possible that, in a same or similar aspect, characteristic information described and indicated in one embodiment is used in one or more other embodiments, combined with characteristic information in other embodiments, or substituted for characteristic information in other embodiments.

It should be emphasized that the term “include(s) or comprise(s)/including or comprising” when used in this specification is taken to specify that characteristic information, a whole member, a step, or a member is present, but does not preclude that one or more other pieces of characteristic information, whole members, steps, or members is or are present/added.

1. A method for inspecting an environmental device, comprising:
using a mobile inspection device to collect data of a site where the environmental device is positioned;
generating information of changes in the site where the environmental device is positioned based on the data collected by the mobile inspection device;
acquiring operation data of the environmental device and information of an initial operation time of the environmental device; and
identifying a health state parameter of the environmental device based on
the information of changes in the site where the environmental device is positioned,
the operation data of the environmental device, and
the information of the initial operation time of the environmental device.

2. The method according to claim 1, wherein
the data collected by the mobile inspection device includes at least one of
data of an image of the environmental device and its surroundings,
radar detection data with respect to the environmental device and its surroundings,
data of vibration of the environmental device, data of sound of the environmental device,
data of an air quantity of the environmental device, and
data of an infrared image of the environmental device and its surroundings.

3. The method according to claim 1, wherein
using the mobile inspection device to collect data of the site where the environmental device is positioned includes
allowing the mobile inspection device to move to a position near the environmental device and/or to stop at the environmental device, and
allowing the mobile inspection device to collect the data of the site where the environmental device is positioned.

4. The method according to claim 3, wherein
allowing the mobile inspection device to move to a position near the environmental device and/or to stop at the environmental device includes
allowing the mobile inspection device to acquire information of a position of the environmental device and/or information of an address of a user from a cloud side or a database, and
allowing the mobile inspection device to move to a position near the environmental device and/or to stop at the environmental device based on the information of the position and/or the information of the address.

5. The method according to claim 4, wherein
allowing the mobile inspection device to move to a position near the environmental device and/or to stop at the environmental device includes
allowing the mobile inspection device to perform a search within a certain region based on the information of the position and/or the information of the address to identify a position of the environmental device, and
allowing the mobile inspection device to move to a position near the environmental device and/or to stop at the environmental device based on the position of the environmental device, the position being identified through the searching.

6. The method according to claim 5, further comprising:
allowing the mobile inspection device to transmit the position of the environmental device, the position being identified through the searching, to the cloud side or the database to update the position of the environmental device.

7. The method according to claim 1, wherein
the information of changes includes at least one of
a ventilation condition for the environmental device,
a degree of cleanliness of the environmental device,
information of shielding of the environmental device,
a drain state,
a quantity of exhaust air of the environmental device,
an installation state of the environmental device,
an ignition risk of the environmental device, and
a refrigerant leakage risk.

8. The method according to claim 7, wherein
generating information of changes in the site where the environmental device is positioned based on the data collected by the mobile inspection device includes
detecting an obstacle outside the environmental device and a position of the obstacle based on data of an image of the environmental device and its surroundings, the data of the image being collected by the mobile inspection device, and radar detection data with respect to the environmental device and its surroundings, and
generating an obstacle coefficient indicating a ventilation condition for the environmental device based on a result of the detection of the obstacle outside the environmental device and the position of the obstacle.

9. The method according to claim 8, wherein
the obstacle includes at least one of a branch, a leaf, a foreign object, and another environmental device.

10. The method according to claim 7, wherein
generating information of changes in the site where the environmental device is positioned based on the data collected by the mobile inspection device includes
acquiring related information and light illumination information of a building where the environmental device is positioned and surrounding buildings based on data of an image of the environmental device and its surroundings, the data of the image being collected by the mobile inspection device, and/or data on a cloud side or data in a database, and
generating a shielding coefficient indicating information of shielding of the environmental device based on the related information and the light illumination information of the building where the environmental device is positioned and the surrounding buildings.

11. The method according to claim 7, wherein
generating information of changes in the site where the environmental device is positioned based on the data collected by the mobile inspection device includes
acquiring data of an image of a condensation water drain outlet of the environmental device and/or a drain outlet of a building based on data of an image of the environmental device and its surroundings, the data of the image being collected by the mobile inspection device, and
generating a drain coefficient indicating a drain state of the environmental device based on the data of the image of the condensation water drain outlet of the environmental device and/or the drain outlet of the building.

12. The method according to claim 7, wherein
generating information of changes in the site where the environmental device is positioned based on the data collected by the mobile inspection device includes
generating an installation stability coefficient indicating an installation state of the environmental device based on at least one of information of operation of a vibration generation member in the environmental device, data of vibration of the environmental device, the data of the vibration being collected by the mobile inspection device, and data of sound of the environmental device.

13. The method according to claim 7, wherein
generating information of changes in the site where the environmental device is positioned based on the data collected by the mobile inspection device includes
identifying a temperature near the environmental device and a temperature of a surface of the environmental device based on data of an infrared image of the environmental device and its surroundings, the data of the infrared image being collected by the mobile inspection device, and
generating an ignition risk coefficient indicating an ignition risk of the environmental device based on a temperature collected by a sensor in the environmental device and/or the temperature near the environmental device and the temperature of the surface of the environmental device, the temperatures being identified based on the data of the infrared image.

14. The method according to claim 7, wherein
generating information of changes in the site where the environmental device is positioned based on the data collected by the mobile inspection device includes
identifying a frosting state of the environmental device based on data of an image of the environmental device and its surroundings, the data of the image being collected by the mobile inspection device, and
generating a refrigerant leakage coefficient indicating a refrigerant leakage risk of the environmental device based on the frosting state of the environmental device.

15. The method according to claim 1, wherein
generating information of changes in the site where the environmental device is positioned based on the data collected by the mobile inspection device includes
inputting the data collected by the mobile inspection device into a model to output information of changes in the site where the environmental device is positioned.

16. The method according to claim 1, wherein
acquiring operation data of the environmental device and information of an initial operation time of the environmental device includes
acquiring operation data of the environmental device within a latest predetermined time or real-time operation data, and
acquiring sign information of the environmental device based on a name plate of the device in an image photographed by the mobile inspection device or based on data on a cloud side to acquire information of an initial operation time of the environmental device based on the sign information of the environmental device.

17. The method according to claim 1, wherein
identifying a health state parameter of the environmental device based on the information of changes in the site where the environmental device is positioned, the operation data of the environmental device, and the information of the initial operation time of the environmental device includes
inputting the information of changes in the site where the environmental device is positioned, the operation data of the environmental device, and the information of the initial operation time of the environmental device into a model to calculate and output a health state parameter of the environmental device.

18. The method according to claim 1, wherein
identifying a health state parameter of the environmental device based on the information of changes in the site where the environmental device is positioned, the operation data of the environmental device, and the information of the initial operation time of the environmental device includes
using a table lookup method to identify a health state parameter of the environmental device based on the information of changes in the site where the environmental device is positioned, the operation data of the environmental device, and the information of the initial operation time of the environmental device.

19. The method according to claim 1, wherein
a health state parameter of the environmental device includes at least one of
a degree of deterioration due to aging, and
a depreciation rate of the environmental device.

20. An inspection system for an environmental device, comprising:
the environmental device serving as an inspection target;
a mobile inspection device; and
a server on a cloud side,
the mobile inspection device being allowed
to move to a position near the environmental device and/or to stop at the environmental device,
to collect data of a site where the environmental device is positioned, and
to transmit the data to the server, and
the server being configured to
receive the data transmitted by the mobile inspection device to generate information of changes in the site where the environmental device is positioned based on the data, and
acquire operation data of the environmental device and information of an initial operation time of the environmental device from the environmental device or the cloud side to further identify a health state parameter of the environmental device based on the information of changes in the site where the environmental device is positioned, the operation data of the environmental device, and the information of the initial operation time of the environmental device.

21. The system according to claim 20, wherein
the server is further configured to provide a servicing or update policy for the environmental device to a user based on the identified health state parameter of the environmental device and a reference value of the health state parameter.

22. The system according to claim 20, further comprising:
a control device configured to control movement, operation, and charging of the mobile inspection device.

23. A mobile inspection device comprising:
a drive module configured to supply a driving force in order to allow the mobile inspection device to move;
a wireless communication module configured to perform wireless communication with at least one of
a control device for the mobile inspection device,
an environmental device, and
a server on a cloud side;
a detection module including at least one of an imaging module, an infrared imaging module, a vibration sensor, a directional sound sensor, a radio detecting and ranging (radar), and an air quantity sensor; and
a global positioning system module that identifies a position of the mobile inspection device.

24. The mobile inspection device according to claim 23, wherein
the mobile inspection device is a drone or an airship.
